(19) United States
(12) Patent Application Publication
(10) Pub. No.: US 2026/0203713 A1
(43) Pub. Date: Jul. 16, 2026

(54) INTELLIGENT DESCRIPTOR-BASED DYNAMIC CONTENT GENERATION AND DELIVERY

(71) Applicant: INTERNATIONAL BUSINESS MACHINES CORPORATION, Armonk, NY (US)

(72) Inventors: Bryan M Buckland, Austin, TX (US); Matthew Francis Rutkowski, Pflugerville, TX (US); Raghuraman Kalyanaraman, Round Rock, TX (US); Nicole Keyes, New York, NY (US)

(21) Appl. No.: 19/019,670

(22) Filed: Jan. 14, 2025

(51) Int. Cl. G06Q 10/10; G06Q 10/0631

(52) U.S. Cl. CPC G06Q 10/103; G06Q 10/06316

(57) ABSTRACT

A project-template, including a set of role-descriptors and a task-descriptor graph, is obtained. The set of role-descriptors includes one or more role-descriptors describing one or more roles relating to a project represented by the project-template and the task-descriptor graph includes a plurality of task-descriptors and one or more weights for the plurality of task-descriptors to indicate one or more relationships between the plurality of task-descriptors. An artificial intelligence application is executed to dynamically generate and deliver descriptor-based content based on a request for content for a role-descriptor. The descriptor-based content includes content based on the role-descriptor and at least one task-descriptor. Data obtained based on the set of role-descriptors and task-descriptor graph is tagged using the artificial intelligence application. Descriptor-based content is generated based on the request, the role-descriptor and the task-descriptor graph. The descriptor-based content, which is specific to the role-descriptor, is delivered.

### BACKGROUND

One or more aspects relate, in general, to dynamic processing within a computing environment, and in particular, to improving such processing.

Currently, users create different versions of content in the form of multiple information artifacts based on the audience. For instance, different power point presentations are created for different audiences (e.g., architects vs. marketing vs. project manager vs. engineers, etc.), since varying content is wanted and/or to be provided to the different audiences. The different versions lead to version sprawl, increased maintainability, increased costs, increased memory usage and the potential of outdated information being shared. This degrades system performance and complicates the generation and delivery of content to users.

### SUMMARY

Shortcomings of the prior art are overcome, and additional advantages are provided through the provision of a method. The method includes obtaining a project-template that includes a set of role-descriptors and a task-descriptor graph. The set of role-descriptors includes one or more role-descriptors describing one or more roles relating to a project represented by the project-template and the task-descriptor graph includes a plurality of task-descriptors and one or more weights for the plurality of task-descriptors to indicate one or more relationships between the plurality of task-descriptors. An artificial intelligence application is executed on at least one computing device to dynamically generate and deliver descriptor-based content based on a request for content for a role-descriptor of the set of role-descriptors. The artificial intelligence application includes one or more artificial intelligence models trained to generate the descriptor-based content. The descriptor-based content includes content based on the role-descriptor and at least one task-descriptor of the task-descriptor graph. Data obtained based on the set of role-descriptors and the task-descriptor graph of the project template is tagged to generate tagged data. The tagged data is stored in a repository. The descriptor-based content to be delivered is generated based on the request. The generating the descriptor-based content uses the artificial intelligence application to generate from the tagged data stored in the repository the descriptor-based content. The generating the descriptor-based content is based on the role-descriptor and the task-descriptor graph. The descriptor-based content is delivered and the descriptor-based content that is delivered is specific to the role-descriptor.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIGS. 2A-2B depict one example of a system overview of intelligent descriptor-based content generation and delivery, in accordance with one or more aspects of the present disclosure;

FIG. 3 depicts one example of intelligent descriptor-based content generation and delivery code of FIG. 1, in accordance with one or more aspects of the present disclosure;

FIG. 4 depicts one example of an intelligent workflow to perform descriptor-based content generation and delivery, in accordance with one or more aspects of the present disclosure; and

FIG. 5 depicts one example of a machine learning training system used in accordance with one or more aspects of the present disclosure.

### DETAILED DESCRIPTION

In one or more aspects, a capability is provided to dynamically generate content to be delivered to a requester of the content. The content is dynamically generated based on a project-template defined for a project. A project may be of various types of projects, including, but not limited to, the design, implementation and/or execution of a product, such as anything that can be constructed or manufactured (e.g., computers, computer hardware, other hardware, buildings, furniture, vehicles, aircraft, watercraft, theme park rides, household goods, appliances, etc.) and/or anything that can be created, generated and/or executed (e.g., computer software, networking, information technology-related, etc.). The product may be a new product or an updated product (e.g., a new release; design change, etc.).

In accordance with one or more aspects, to facilitate dynamic generation of content, a project is defined by a project-template, which is a reusable template that defines for a project a set of role-descriptors that describes a set of roles related to the project (e.g., designer, owner, engineer, architect, marketing, advertising, finance, etc.) and includes a task-descriptor graph that includes a plurality of task-descriptors describing stages or phases of the project (e.g., ideation/cost, planning/design, build, marketing/advertising, post-delivery, etc.). In one example, the task-descriptor graph is an N dimensional graph, such as an N-dimensional directed acyclic graph, in which N is equal to or greater than 1 and there may be one or more branches from each task-descriptor node of the graph. The graph includes, for instance, the plurality of task-descriptors as a plurality of nodes of the graph and one or more weights used to determine relative importance of task-descriptors for particular role-descriptors. For instance, when one or more role-descriptors are applied to the task-descriptor graph, the weights of the task-descriptors are relative in importance to the role-descriptors. In one or more aspects, weights may be adjusted such that lower weights indicate less importance or prioritization for generating content/output (e.g., less interest to the role defined by the role-descriptor) relative to other task-descriptor nodes described in the overall graph. Conversely, higher weights imply greater importance or prioritization to the role defined by the role-descriptor relative to other task-descriptor nodes, and thus, more content is generated to be delivered. Other examples are possible.

In one example, when generating content views, where task-descriptors have low weights (as defined relative to other weights; e.g., a weight of x to y is considered low and anything over y is considered high; etc.), the generation (e.g., via a generation tool, process, etc.) seeks to reduce presentation Z-order, and conversely raise it for higher weights. Further, in one example, generation may choose not to generate content for task-descriptors whose weights are below a preselected threshold. Other examples are possible.

In one or more aspects, different content is dynamically generated for various identified role-descriptors having various levels of functional interests, knowledge levels, responsibilities and accustomed content formats. However, the individualized content that is dynamically generated is not independently stored. Instead, data related to the project is stored in one or more repositories, and the individualized content is generated from the data based on a request for a role-descriptor and delivered in a format customized for that role-descriptor. This saves on storage and the time it takes to update multiple versions of content for multiple role-descriptors.

In one or more aspects, to deliver the content in the accustomed content format, an indication of a desired format for a role-descriptor is provided. This may be accomplished in a number of ways, including but not limited to, a registration mechanism in which a role-descriptor is registered as a specific role-descriptor and context regarding the role-descriptor is provided, such as content format (and/or other context, such as particular task-descriptors it is interested in; relationships to other role-descriptors; etc.); providing a data structure that includes the role-descriptors and their contexts; using an application programming interface (API) that provides the role-descriptors and their contexts; including the information in the project-template; etc. Many mechanisms are possible for providing role-descriptors and associated context for the role-descriptors.

In one example, to generate the appropriate content for the role-descriptor in the desired form of the role-descriptor, an intelligent workflow is executed. An intelligent workflow is the orchestration of automation, artificial intelligence, analytics, and skills to fundamentally change how work is performed. In one or more aspects, an intelligent workflow is defined and used to dynamically generate content for a role-descriptor and deliver that content. The intelligent workflow executes an artificial intelligence application that includes one or more trained artificial intelligence models, and therefore, may be referred to herein as an artificial intelligence workflow. As applied to intelligent descriptor-based content delivery, in one or more aspects, the intelligent workflow dynamically generates the content to be delivered based on the role-descriptor, the project phase and/or one or more task-descriptors defined in the project-template; delivers the generated content to the requester of the content in the role-descriptor's desired format; and improves the intelligent workflow. Other examples are possible.

In one or more aspects, to dynamically generate and deliver descriptor-based content, artificial intelligence is used. The artificial intelligence used includes one or more types, fields and/or strategies, such as machine learning (e.g., uses data and algorithms to imitate the way humans learn) and/or generative artificial intelligence (e.g., one or more deep-learning models capable of generating content based on data on which they were trained), as examples. The artificial intelligence executes one or models (e.g., programs that apply algorithms(s) to data to learn, e.g., recognize patterns, make predictions and/or make decisions without human intervention). As used herein, an artificial intelligence application includes one or more models trained to generate and deliver the descriptor-based content. For instance, the artificial intelligence application executes the one or more models to generate and deliver the descriptor-based content. As examples, one model may be trained for all aspects of generating and delivering descriptor-based content or various models are used for various aspects. Many examples are possible.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of performing descriptor-based content generation and delivery, generating and/or executing an intelligent workflow (or multiple workflows or processes) that performs, e.g., descriptor-based content delivery and/or performing one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

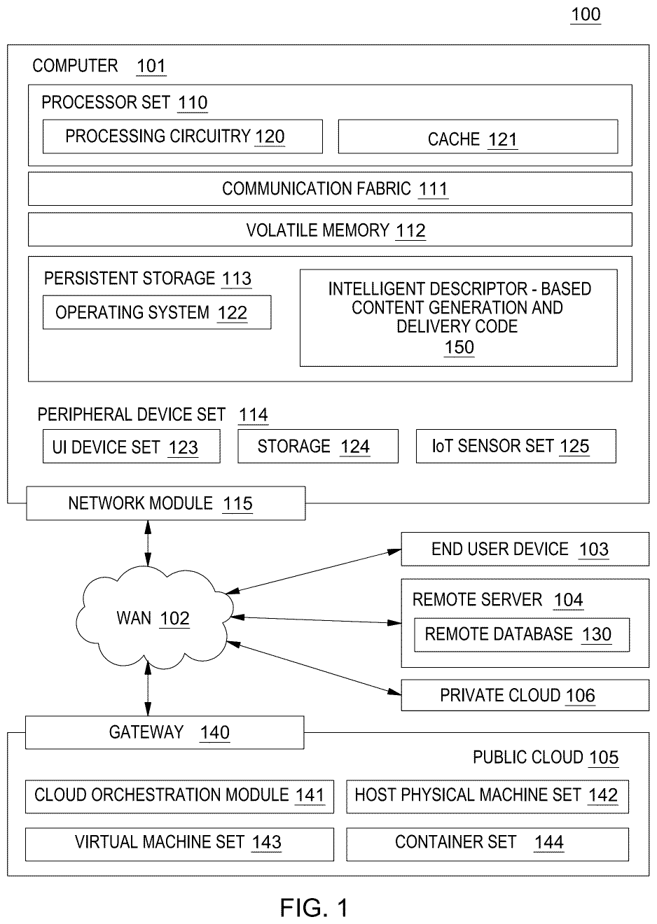

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as intelligent descriptor-based content delivery code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.
The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

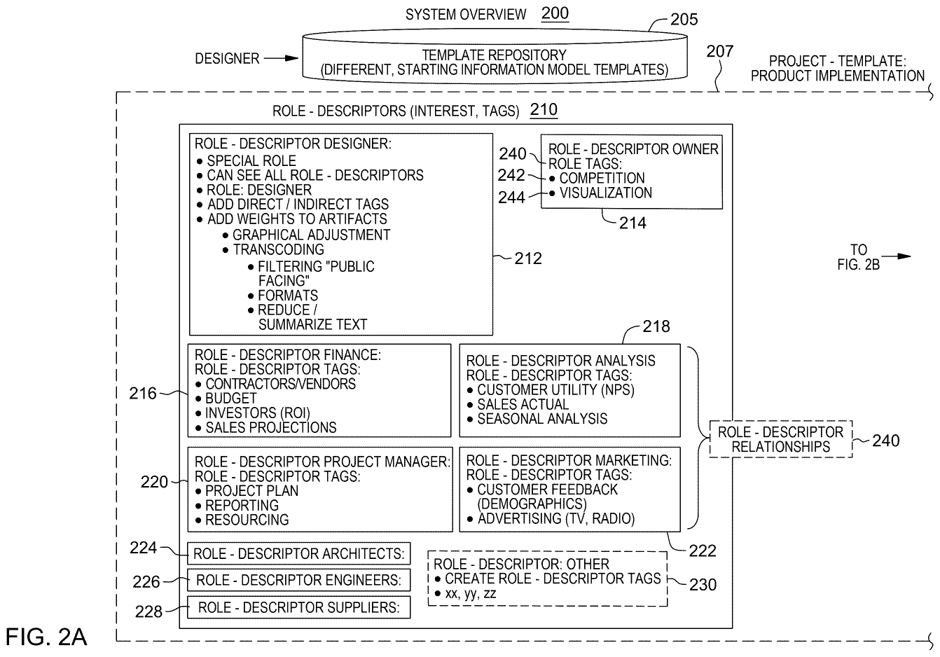

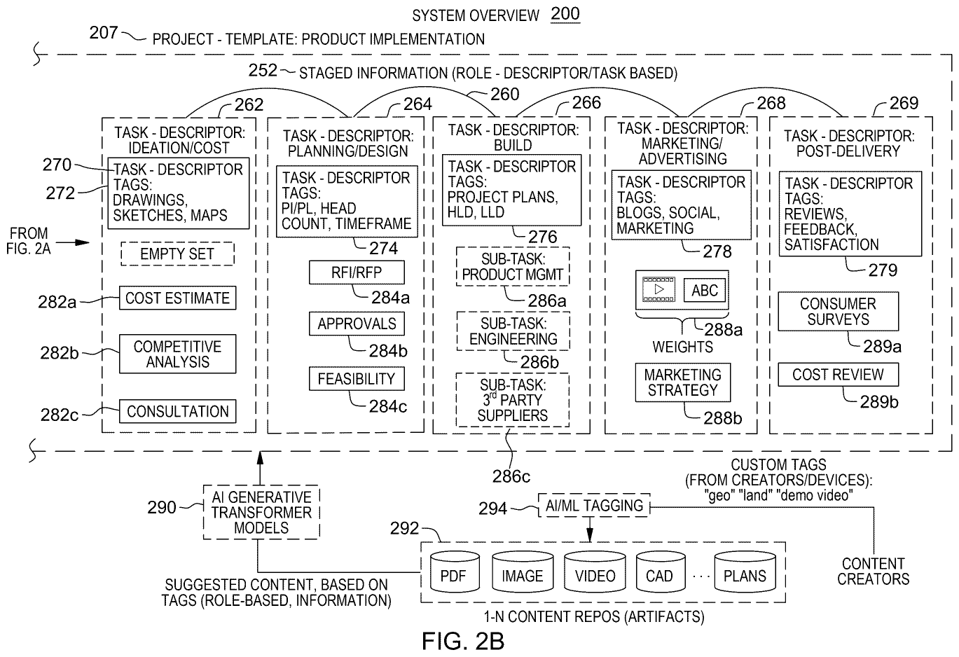

In one or more aspects, content is generated and delivered based on a role-descriptor and/or one or more task-descriptors that are related to the role-descriptor of a given project, as defined by the project-template. Instead of users creating multiple versions of content (e.g., multiple versions of artifacts, such as files, videos, presentations, power points, documents, plans, blueprints, etc.) based on the audience, which leads to many versions of content (referred to as version sprawl), increases maintainability and has the potential of sharing outdated information, the content is now dynamically generated based on the role-descriptor and/or one or more task-descriptors defined in the project-template. A single set of content of conceptually related objects is created and shared, in accordance with one or more aspects of the present disclosure. As an example, content for a project is stored in a repository, and individualized content is generated therefrom based on the role-descriptors and task-descriptors defined in the project-template generated for the project. Presentable content is dynamically generated and delivered from the set of content for various identified role-descriptors with various levels of functional interests, responsibilities or concerns, with various knowledge levels, depth and width and accustomed to having information presented in different consumption formats. In one example, generative artificial intelligence uses indicated criteria (e.g., role-descriptors, levels and consumption formats) to generate content relative to a project-template (e.g., conceptual project-template) for a given consumption format. This is further described with reference to FIGS. 2A-2B, which depict one example of a system overview for intelligent descriptor-based content delivery.

In one example, referring to FIGS. 2A-2B, a system overview 200 includes, for instance, a template repository 205 from which a project-template 207 is selected for the given project (e.g., implementation of a product, or another project). In one example, project-template 207 includes a plurality of role-descriptors 210 defined for a project and a plurality of task-descriptors 260 (FIG. 2B) created for a project. In one example, the project is implementation of a product, and the plurality of role-descriptors include, for instance, a designer role-descriptor 212, an owner role-descriptor 214, a finance role-descriptor 216, an analysis role-descriptor 218, a project manager role-descriptor 220, a marketing role-descriptor 222, one or more architect role-descriptors 224, one or more engineer role-descriptors 226, one or more supplier role-descriptors 228 and/or one or more other role-descriptors 230. The plurality of role-descriptors may be dynamically defined based on the project and may be different for different projects. Many examples are possible.

As examples, the role-descriptors may be defined by a designer and/or dynamically defined using artificial intelligence that indicates the role-descriptors based on the project. For instance, the project of product implementation (identifying the product to be implemented) is input to at least one artificial intelligence model that generates a list of roles and/or role-descriptors. The list of roles and/or role-descriptors may be used as the plurality of role-descriptors and/or the designer may select from the list of roles and/or role-descriptors and/or add to the list of roles and/or role-descriptors. Other examples are possible.

In one example, a designer role-descriptor 212 is defined and it is specified, for instance, as a special role, since it can see the other role-descriptors and/or is used to perform certain actions for its role-descriptor and/or other role-descriptors. For instance, it may assist in defining other role-descriptors, which may depend on the project. Further, it may be used to add direct/indirect tags to content, add weights to artifacts to indicate importance of one type of artifact over another and/or add weights to data to indicate importance of selected data over other data, etc. As examples, a direct tag is designed by, e.g., the designer and is predefined, an indirect tag is generated by, e.g., an artificial intelligence agent based, e.g., on inspecting data in the repository, and weights may be based on, e.g., internet connection/device, whether to display a video or text, based on the importance of the content to be displayed (e.g., multiple pictures), etc. The designer role-descriptor may specify graphical adjustments to be made and/or perform transcoding to convert one encoding of an artifact to another encoding, provide filtering (e.g., public facing), indicate formats and/or reduce/summarize text. Weights may be used to indicate which of these actions are to be taken. Other examples are possible.

A role-descriptor 210 has context information associated therewith including, but not limited to, one or more role-descriptor tags 240 that provide role-descriptor-based information. For instance, for owner role-descriptor 214, role-descriptor tags 240 may include, in one example, a competition tag 242 and a visualization tag 244. Additional, fewer and/or other role-descriptor tags may be assigned to owner role-descriptor 214. Further, other role-descriptors may have other role-descriptor tags assigned thereto. As examples, finance role-descriptor 216 includes the following role-descriptor tags, in one example: contracts/vendors, budget, investors (return on investment (ROI)) and/or sales projections; analysis role-descriptor 218 includes the following role-descriptor tags, in one example: customer utility, actual sales and/or seasonal analysis; project manager role-descriptor 220 includes the following role-descriptor tags, in one example: project plan, reporting and/or resourcing; marketing role-descriptor 222 includes the following tags, in one example: customer feedback (e.g., demographics) and/or advertising (e.g., television, radio, online, etc.). A role-descriptor may have one or more role-descriptor tags, and the example role-descriptor tags are just examples. Each role-descriptor may have additional, fewer and/or other role-descriptor tags assigned thereto. The role-descriptor tags may be defined by the designer manually or automatically based on the project, and/or dynamically assigned using artificial intelligence. For instance, one or more artificial intelligence models (e.g., machine learning models and/or other artificial intelligence models) define the role-descriptor tags based on the defined role-descriptors for the particular project. Other examples are possible.

In one or more aspects, a role-descriptor may have a relationship 240 with one or more other role-descriptors. As such, at least a portion of the content generated for one role-descriptor may be delivered for one or more other role-descriptors to which the one role-descriptor has a role-descriptor relationship. Role-descriptor relationships may be indicated in the project-template, as part of the role-descriptor registration context or in other ways.

In one example, for each project, project-template 207 (FIG. 2B) includes staged information 252 based on role-descriptors 210 and task-descriptors 260 defined within the project-template for the project (e.g., implement a product). As one example, a designer/creator of the project (e.g., product to be implemented) may select a previously defined project-template from a repository (e.g., template repository 205). The project-template comes, e.g., with a set of task-descriptors 260 and/or a set of role-descriptors 210 that are typically used for the project. The project-template may be dynamically modified based on input provided by, e.g., the designer. Moreover, a project-template may be created based on the project and using artificial intelligence. The created project-template may be saved in the repository for selection and use by other designers. Many examples are possible.

In one example, project-template 207 includes a plurality of task-descriptors 260, including but not limited to, an ideation/cost task-descriptor 262, a planning/design task-descriptor 264, a build task-descriptor 266, a marketing/advertising task-descriptor 268 and a post-delivery task-descriptor 269. A project-template (e.g., project-template 207) may have additional, fewer and/or other task-descriptors (and/or role-descriptors). The task-descriptors described herein are just examples and many other examples are possible. The task-descriptors for a project may be defined by a designer manually or automatically based on the project, and/or dynamically assigned using artificial intelligence. For instance, one or more artificial intelligence models (e.g., machine learning models and/or other artificial intelligence models) may be trained and/or used to generate the plurality of task-descriptors based on a given project. Further, the designer may use the artificial intelligence generated task-descriptors and/or select therefrom and/or add to those generated task-descriptors. Many examples are possible.

Each task-descriptor 260 defined in the project-template for a particular project includes, for instance, one or more task-descriptor tags 270 that suggest types of content for the task-descriptor/role-descriptor. For example, for task-descriptor 262 (e.g., ideation/cost), task-descriptor tags 272 include, e.g., drawings, sketches and maps; for task-descriptor 264 (e.g., planning/design), task-descriptor tags 274 include, e.g., PI/PL (program increment/program plan), head count, timeframe; for task-descriptor 266 (e.g., build), task-descriptor tags 276 include, e.g., project plans, HLD (high-level design), LLD (low-level design); for task-descriptor 268 (e.g., marketing, advertising), task-descriptor tags 278 include, e.g., blogs, social, marketing; and for task-descriptor 269 (e.g., post-delivery), task-descriptor tags 279 include, e.g., reviews, feedback, satisfaction. Each task-descriptor may have additional, fewer and/or other task-descriptor tags. The task-descriptor tags described herein are just examples and many other examples are possible.

In one example, each task-descriptor may be populated in the project-template with at least one empty set for one or more role-descriptors. An empty set may be replaced by a description of content to be provided based on the role-descriptor. For example, for task-descriptor 262: an empty set for finance role-descriptor 216 is replaced by cost estimates 282a, an empty set for analysis role-descriptor 218 is replaced by competitive analysis 282b, and an empty set for marketing role-descriptor 222 is replaced by consultation 282c. As another example, for task-descriptor 264: an empty set for finance role-descriptor 216 is replaced by RFI (request for information)/RFP (request for proposal) 284a, an empty set for owner role-descriptor 214 is replaced by approvals 284b, and an empty set for project manager role-descriptor 220 is replaced by feasibility 284c. For task-descriptor 266, in one example, sub-task-descriptors are defined including, for instance, sub-task-descriptor product management 286a for project manager role-descriptor 220, sub-task-descriptor: engineering 286b for engineer role-descriptor 226, and sub-task-descriptor third party supplier 286c for supplier role-descriptor 228. In another example, for task-descriptor 268: an empty set for marketing role-descriptor 222 is replaced by advertising 288a (e.g., television) and marketing strategy 288b. Further, in one example, weights are used for advertising 288a. In yet another example, for task-descriptor 269: an empty set for analysis role-descriptor 218 is replaced by consumer surveys 289a, and an empty set for finance role-descriptor 216 is replaced by cost review 289b. Many other examples are possible.

In one aspect, content, as described by the content descriptions associated with task-descriptors 260, is dynamically generated for a role-descriptor based on data (e.g., content) created and stored in one or more repositories 292 (also referred to as content repositories) and may be presented as different types of artifacts, including, but not limited to, pdfs (portable document formats), images, videos, CAD (computer-aided design), plans, documents, power points, etc.

In one aspect, selected data is tagged 294 based, for instance, on the role-descriptor tags and/or the task-descriptor tags. For instance, considering the role-descriptor tags and/or the task-descriptor tags, data in the content repositories is reviewed and data that appears relevant to the role-descriptor tags and/or task-descriptor tags are tagged providing metadata that describes the tagged data. The tagging is performed, in one example, automatically using artificial intelligence tagging (e.g., artificial intelligence (AI)/machine learning (ML) tagging 294). The tagging facilitates dynamic generation of content to be delivered (e.g., presented, provided, forwarded, displayed, visualized, etc.) for a role-descriptor. As an example, the artificial intelligence is trained in how to tag the data based on the role-descriptors (e.g., role-descriptor tags) and/or task-descriptors (e.g., task-descriptor tags), and this training is continuous in that the artificial intelligence continues to learn and retrains itself based on the learning. In one example, artificial intelligence may be used to clean/standardize the tags associated with the data. Many examples are possible.

In one or more aspects, the content provided for a role-descriptor is dynamically generated based on the role-descriptor, task-descriptors used by the role-descriptor and the content descriptions defined for the role-descriptor and/or task-descriptors. As an example, the content is dynamically generated for delivery for the role-descriptor using artificial intelligence (e.g., one or more artificial intelligence (AI) generative transformer models 290). The models are trained (and retrained based on learning) based on the types of projects, role-descriptors and task-descriptors. In one example, data is created and/or suggested to train the models. Such data may be created and/or suggested by, e.g., designers, architects, engineers, employees, team leads, experts in the field, scholars, students, vendors, contractors, machine learning and/or other aspects of artificial intelligence, etc. Many sources are possible for the data.

In one or more aspects, additional, fewer and/or other role-descriptors and/or task-descriptors may be defined based on the end-audience, level of knowledge of the user, project, etc. Many examples are possible.

In one example, the content dynamically generated for a role-descriptor may be for a selected task-descriptor and/or one or more task-descriptors. In one example, the role-descriptor indicates (e.g., via an application programming interface) for which task-descriptor(s) it is requesting content. As another example, it may be based on default and/or dynamically determined (e.g., using artificial intelligence). Other examples are possible.

As described herein, artificial intelligence (e.g., generative artificial intelligence) is leveraged to intelligently bring together relative project role-descriptors, data in multiple repositories, and informational project-templates. The project-templates organize information around a project designed from start to finish and consider the lifecycle stages from data collection and tagging, through to the presentation around a scope of work (e.g., project). Based on the project and project-templates including the role-descriptors and/or task-descriptors included therein, data is collected (e.g., using tags and descriptive text that can be used to construct prompts). As an example, dynamic prompt design is used for data/information tagging and filtering using, e.g., a content assistant (e.g., artificial intelligence). In one or more aspects, data can be designed, organized and related for customized targeted presentation to end users (e.g., requesting roles) at their determined role-descriptor-based knowledge level, responsibilities, functional interests and consumption formats. A create once but share everywhere technique is provided. This is instead of creating and storing separate artifacts (e.g., files, etc. that include content, data, etc.) for each targeted role-descriptor, which increases memory usage and may lead to the use of outdated data.

In one example, to dynamically generate and deliver descriptor-based content, intelligent descriptor-based content generation and delivery code (e.g., intelligent descriptor-based content generation and delivery code 150) is used, in accordance with one or more aspects of the present disclosure. Intelligent descriptor-based content generation and delivery code (e.g., intelligent descriptor-based content generation and delivery code 150) includes code or instructions used to dynamically generate and deliver descriptor-based content, in accordance with one or more aspects of the present disclosure. The code is, e.g., computer-readable program code (e.g., instructions) in computer-readable media, e.g., storage (e.g., persistent storage 113, cache 121, storage 124, other storage, as examples). The computer-readable media may be part of a computer program product and the computer-readable program code may be executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the code and/or portions thereof. Many examples are possible.

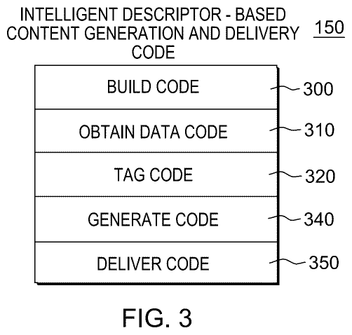

One example of intelligent descriptor-based content generation and delivery code 150 is described with reference to FIG. 3. In one example, intelligent descriptor-based content generation and delivery code 150 includes build code 300 to be used to build and/or select one or more project-templates to be used in intelligent descriptor-based content delivery; data obtain code 310 to be used to obtain data from a variety of sources; tag code 320 to be used to tag the obtained data; generate code 340 to be used to generate the descriptor-based content to be delivered; and delivery code 350 to be used to deliver the generated descriptor-based content. Additional, less and/or other code may be provided and/or used in one or more aspects of the present disclosure.

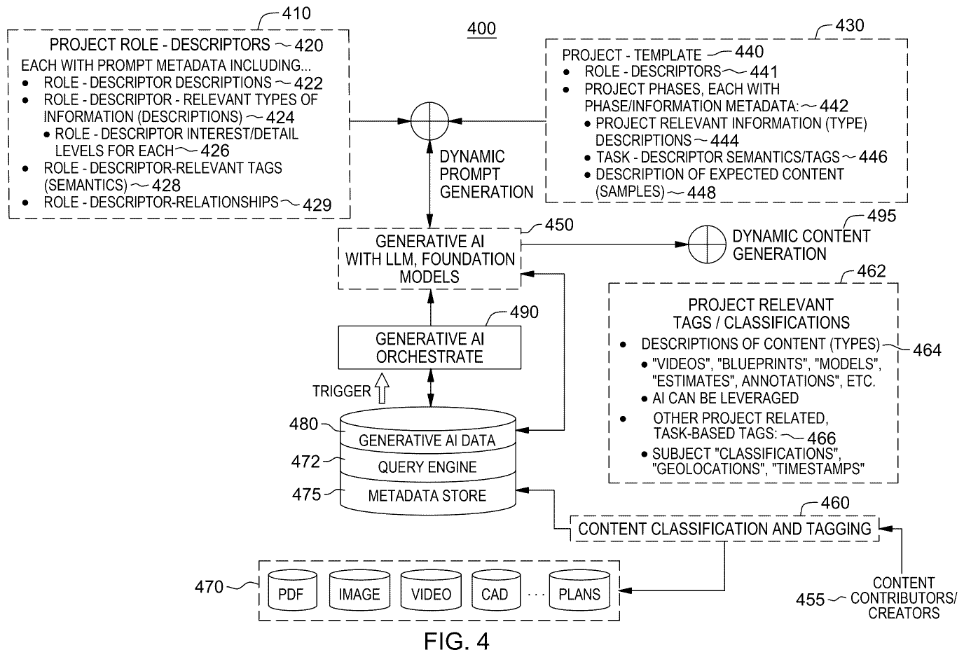

In one example, intelligent descriptor-based content generation and delivery code 150 includes code (e.g., code 300-350) that is used in descriptor-based content generation and delivery processing, as further described in one example with reference to FIG. 4. FIG. 4 depicts one example of an intelligent workflow 400 (and/or processing) that is executed by one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the workflow, the processing and/or portions thereof. Various options are possible.

Referring to FIG. 4, in one example, intelligent workflow 400 (also referred to as workflow 400 or artificial intelligence workflow) dynamically generates content to be delivered for a role-descriptor. The content generated and delivered is based on the requesting role-descriptor of a project and task-descriptors defined in a project-template designed for the project. Role-descriptors relating to the project, as well as task-descriptors of the project and content descriptions, may be defined based on prompts provided by a designer and/or automatically generated by artificial intelligence based on the project. In one example, workflow 400 uses, e.g., artificial intelligence 450 (e.g., generative artificial intelligence, one or more large language models, foundation models, etc.) to dynamically generate prompts used in defining the project role-descriptors, task-descriptors and/or the project-templates. In one example, a project-template is predefined and obtained (e.g., provided, pulled, retrieved, etc.) by intelligent workflow 400 and that project-template includes the set of role-descriptors and a task-descriptor graph that includes a plurality of task-descriptors. Other examples are possible.

In one aspect, workflow 400 defines 410 one or more role-descriptors 420 for a given project. The role-descriptors may be defined by a designer and/or automatically by e.g., artificial intelligence 450 based on the project. In one example, prompts may be used to facilitate the defining of a role-descriptor and context information (e.g., metadata) for the role-descriptor. The context information includes, e.g., one or more role-descriptor descriptions 422, role-descriptor-relevant types of information 424 (e.g., descriptions) and information, such as role-descriptor interest and detail levels 426 for each, role-descriptor-relevant tags 428 and role-descriptor relationships 429, if any. In one example, a project-template is predefined that includes the set of role-descriptors and/or context information for a given project. Additional, fewer and/or other metadata may be provided. Many examples are possible.

Further, in one example, workflow 400 builds 430 (e.g., using build code 300) one or more project-templates 440 (also referred to as templates herein) or selects from, e.g., a repository one or more project-templates 440. A project-template 440 includes, for instance, a set of role-descriptors 441 and a definition of one or more project phases, each with phase information metadata 442 including, for instance: project relevant information (type) descriptions 444, such as task-descriptors, task-descriptor specific tags/semantics 446; and/or a description of expected content (samples) 448 (also referred to herein as content descriptions). Additional, fewer and/or other metadata may be provided. Many examples are possible. Project-templates may be predefined and saved and/or dynamically generated for a project based on a request. A predefined project-template includes, in one example, a set of role-descriptors and a task-descriptor graph including a set of task-descriptors typically used for the project. The set of role-descriptors and/or the set of task-descriptors may be revised based on a given instance of the project. Other examples are possible.

In one example, workflow 400 orchestrates, using, e.g., data obtain code 310, the creation 455 of data (e.g., creation, contribution, selection, provision, etc.) by content creators (e.g., designers, architects, engineers, employees, team leads, experts in the field, scholars, students, vendors, contractors, contributors, machine learning and/or other aspects of artificial intelligence, etc.), based on the project, and/or defined role-descriptors and/or task-descriptors defined in a project-template. The content is stored in one or more repositories 470 (e.g., pdfs, images, videos, CAD, plans, documents, power points, etc.). Further, in one or more aspects, workflow 400 tags 460 and/or classifies (e.g., using tag code 320) selected data based on the project, role-descriptors and/or task-descriptors to facilitate generating and delivering content for a role-descriptor. In one example, artificial intelligence (e.g., generative artificial intelligence) may be used to perform the classification and/or tagging with or without input from content creators. This is a dynamic process that changes, as the artificial intelligence models learn of the role-descriptors and/or task-descriptors. The tags may be stored, for instance, in a metadata store 475 and are used to tag data stored in the repository.

In one example, workflow 400 defines task-descriptor tags 462 (also referred to as project relevant tags/classifications), which may include, for instance, descriptions of content/types 464, such as videos, blueprints, models, estimates, annotations, etc.; and/or other project-related and/or task-descriptor-based tags 466, which may have subjects of, e.g., classifications, geolocations, timestamps, as examples. In one or more aspects, one or more of the task-descriptor tags and/or descriptions may be generated using artificial intelligence. For instance, workflow 400 uses tag code 320 to tag data pertaining to the tags.

In one example, workflow 400 dynamically generates 490 content (e.g., using generate code 340) to be delivered for a role-descriptor. In one example, workflow 400 uses, e.g., a query engine 472, metadata (e.g., tags) in metadata store 475 and/or generative AI data (data generated using generative AI) 480 to dynamically generate 495 content to be delivered. Workflow 400 orchestrates 490 using, e.g., artificial intelligence 450 dynamic generation of content 495 to be provided for the role-descriptor.

Workflow 400 delivers (e.g., presents, provides, forwards, displays, etc.) using, for instance, deliver code 350 the dynamically generated content. In one example, the generated content is provided to a requester for the role-descriptor via one or more networks.

In one example, the content generated and delivered for a role-descriptor is descriptor-based in that it takes into account the role-descriptor and one or more task-descriptors associated, via, e.g., a project-template, with the role-descriptor. In one example, the task-descriptors have weights assigned thereto, which are used in one or more examples to generate and deliver content for the role-descriptor. For instance, when one or more role-descriptors are applied to the task-descriptor graph, the weights of the task-descriptors are relative in importance to the role-descriptors. In one or more aspects, weights may be adjusted such that lower weights indicate less importance or prioritization for generating content/output (e.g., less interest to the role defined by the role-descriptor) relative to other task-descriptor nodes described in the overall graph. Conversely, higher weights imply greater importance or prioritization to the role defined by the role-descriptor relative to other task-descriptor nodes, and thus, more content is generated to be delivered.

Therefore, if, for instance, the role-descriptor is finance, then weights are used to show that task-descriptors of, e.g., ideation/cost (e.g., task descriptor 262), planning and design (e.g., task descriptor 264) and post-delivering (e.g., task descriptor 269) are of greater importance and thus, have, e.g., a higher weight relative to weights assigned to other task-descriptors (e.g., task-descriptors 266 and 268). Other examples are possible.

In other examples, weights may be used to indicate which type of content generated for a task-descriptor and for a role-descriptor is more relevant than other content. For instance, if other content besides, e.g., cost estimates (e.g., cost estimates 282a) is generated for task-descriptor ideation/cost (e.g., task-descriptor 262), then weights may be used to define relative importance for content generation and/or delivery of the cost estimates versus the other content, etc. Many examples are possible.

Although various capabilities of an intelligent workflow are described herein, in other embodiments, an intelligent workflow may include additional, fewer and/or other capabilities. The capabilities/aspects described herein are just examples. Further, one or more aspects may be performed by processing that may or may not utilize an intelligent workflow.

Described above is one example of an intelligent workflow. One or more aspects of the intelligent workflow and/or intelligent descriptor-based generation content and delivery processing may use artificial intelligence including, machine learning. For instance, machine learning and/or other artificial intelligence may be used to train the workflow and/or content generation/delivery process(es), execute the workflow and/or content generation/deliver process(es), and/or perform other tasks. A system is trained to perform analyses and learn from input data and/or choices made.

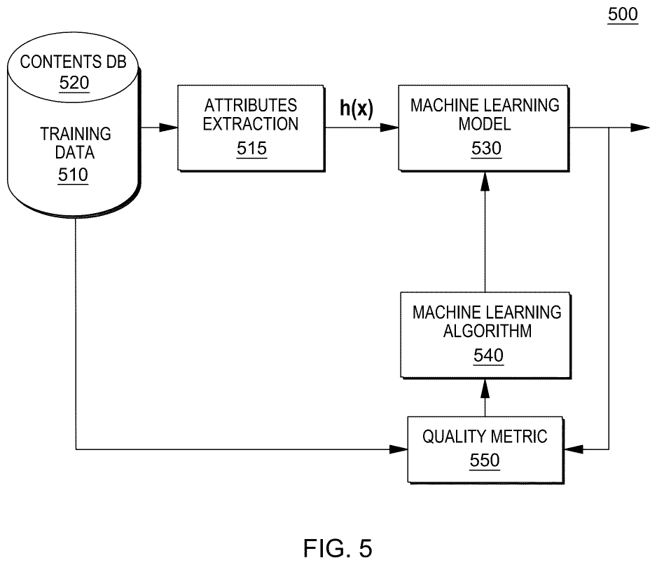

One example of a machine learning training system is described with reference to FIG. 5. In one or more aspects, a machine learning training system 500 may be utilized to perform cognitive analyses of various inputs, including input data, data from one or more sources, repositories, data structures and/or other data. The data may include information for a project, information related to role-descriptors and/or task-descriptors of a project, information of one or more project-templates, etc. Training data utilized to train the model in one or more embodiments of the present disclosure includes, for instance, data that pertains to one or more events, such as natural language processing data, data being processed; data that pertains to projects, project-templates, role-descriptors and/or task-descriptors; data relating to devices, including monitors, sensors, environmental devices, etc.; data obtained from the devices; data obtained from exogenous sources (e.g., project information, role-descriptor information, task-descriptor information, etc.); actions that have been taken; and/or available resources; etc. The program code in embodiments of the present disclosure performs a cognitive analysis to generate one or more training data structures, including algorithms utilized by the program code to predict states of a given event (e.g., content generation/delivery, etc.). Machine learning (ML) solves problems that are not solved with numerical means alone. In this ML-based example, program code extracts various attributes from ML training data 510 (e.g., historical attribute data collected from various data sources relevant to the event (e.g., descriptor-based content generation/delivery for a project)), which may be resident in one or more databases 520 comprising event or descriptor-related data and general data. Attributes 515 are utilized to develop a predictor function, h(x), also referred to as a hypothesis, which the program code utilizes as a machine learning model 530.

In identifying various event states, features, attribute similarities, constraints and/or behaviors indicative of states in the ML training data 510, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 540 to train the machine learning model 530 (e.g., the algorithms utilized by the program code), including providing weights for the conclusions, so that the program code can train the predictor functions that comprise the machine learning model 530. The conclusions may be evaluated by a quality metric 550. By selecting a diverse set of ML training data 510, the program code trains the machine learning model 530 to identify and weight various attributes (e.g., data attributes, features, patterns, constraints, distributions, etc.) that correlate to various states of an event.

The model generated by the program code is self-learning as the program code updates the model based on active event feedback, as well as from the feedback received from data related to the event. For example, when the program code determines that there is a constraint, event, similarity or pattern (e.g., data attribute, record attribute similarity, query pattern, data distribution, search terms distribution, etc.) that was not previously predicted by the model, the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes an existing cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data to generate the model utilized to predict the state of a given event at a given time. Neural networks are biologically-inspired programming paradigms, which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns (or similarities) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event.

As described herein, an intelligent workflow and/or content generation/delivery process(es) are provided that use artificial intelligence to perform descriptor-based content generation and delivery. As an example, the intelligent workflow and/or content generation/delivery process(es) is used in the design and implementation of a product release, including, but not limited to, the manufacturing of a physical product or informational technology product. The information modeling considers different role-descriptors for different roles, such as product owner, architect, engineer, marketing, consumer, etc. Each of these role-descriptors uses different information presented in different formats.

Another example of using an intelligent workflow and/or content generation/delivery process(es) to generate and deliver selective content for a role-descriptor is the design and implementation of a theme park ride. The information modeling considers different role-descriptors that use different content at different levels of detail used for different goals at different times of the overall design, development and delivery lifecycle of the project. The information targets roles defined by role-descriptors with various interests and knowledge including, for example, business owners, marketing; architects, engineers, contractors; and/or media, customer/consumer, etc. Each of these role-descriptors uses different content presented in different formats.

Another example of using an intelligent workflow and/or content generation/delivery process(es) to generate and deliver content for a role-descriptor is the design and implementation of a cookbook or other type of book that describes recipes or procedures. There would be different role-descriptors, depending on the end user of the book, and a recipe, as an example, could be tailored to a home cook, restaurant chef, dietary habits, marketing, customer/consumer feedback, etc. Each of these role-descriptors uses different content presented in different formats.

In one or more aspects, a generalized model is provided for artifact production with a descriptor-based modelling aspect. The concept model is visually represented (e.g., pptx (power point presentation), mural, website, etc.). An artifact is produced that includes valuable information that pertains to a specific role-descriptor and viewable by a particular role-descriptor. A presentation is generated that is viewable by a specific role defined by a specific role-descriptor and it includes only the information that the role-descriptor is to view. In one or more aspects, objects that are specific to a particular role-descriptor are embedded and the same artifact displays a different object when the role-descriptor changes. A generalized model is generated for artifact production based on a specific role-descriptor. In one or more aspects, role-descriptors, role-descriptor descriptions and semantic tags are leveraged by artificial intelligence as part of descriptor-based content generation and delivery. Artificial intelligence is used to dynamically render the content relative to information project-templates or use project-scoped tagged content repositories.

One or more aspects are tied to computer technology and facilitate processing within a computer, improving performance thereof. In one or more aspects, technical fields of computing and artificial intelligence are improved. For instance, the generation and/or execution of intelligent workflows and content generation/delivery processes is facilitated and/or improved. Processing is facilitated by dynamically changing the workflow and/or processes. The dynamic generation and delivery of descriptor-based content saves on memory/storage requirements by not requiring storing of each possible content.

In one or more aspects, a tailored intelligent workflow is generated to generate and deliver content specific to a particular role-descriptor and task-descriptors to be performed for that role-descriptor for a project. In one or more aspects, continuous feedback and improvement are performed. The experiences are used to improve, e.g., the large language model so that the next role-descriptor/stage is improved based on experience. Recommended training is provided so the next iteration is improved and/or faster.

In one or more aspects, a create once, share anywhere technique is provided, in which time is saved, version sprawl is reduced, out-of-date information is less likely to be shared, and/or the maintaining of updated information is less complex. Instead, artificial intelligence is used to leverage descriptor-based project-templates for repeatable management and presentation of information. An individual managing a project or service that is to share and coordinate information to a wide and varied set of entities may: leverage artificial intelligence against a managed data set, across the life cycle of the project to suggest and create content for descriptor-based information project-templates, based upon role-descriptor and consumption format; dynamically create prompts, based upon defined project role-descriptors, as well as classified/tagged project-relevant content sourced from multiple project repositories; manage workflows, represented as project-templates, using orchestration to create and deliver for/to different consumption formats. The templated information mapping templates across the different industries or task-descriptor specific workflows is re-usable.

In one or more aspects, a capability of designing conceptually related objects is provided that includes, for instance, collecting and tagging data based on e.g., role-descriptors, in which tagged data is stored in, e.g., a conceptual project-template repository; filtering the tagged data using a machine learning model, in which the machine learning model standardizes a set of tags associated with the tagged data; building, e.g., a conceptual project-template, in which the tagged data is assigned to one or more concepts based on a task-descriptor and each of the one or more concepts is comprised of role-descriptors, in which the conceptual project-template includes the relationships between the role-descriptors; and generating a visual representation of a set of problems corresponding to the conceptual template.

In one or more aspects, descriptor-based descriptions and interests (and tags) are utilized to relate interests in concepts (e.g., task-descriptors) (defined for against a project-template or instance of a project-template of relational concepts) along with selected artifacts/views those role-descriptors expect or prefer. These descriptor-to-concept relationships are used to suggest/provide content relative to concepts which can also be used to generate views of those relational concepts. Information collected is based on each role-descriptor and combined to generate a full document (e.g., content to be delivered). Each individual user fills in only the data that is relevant to their role-descriptor. Content is customized and displayed to users based on role-descriptors.

One or more aspects generate relevant content to a set of relational concepts (e.g., task-descriptors), against a larger project. In one or more aspects, data is applied to a set of relational concepts that itself provides additional inputs to the overall generating and presenting against a larger project context.

The computing environments described herein are only examples of computing environments that can be used. One or more aspects of the present disclosure may be used with many types of environments. Each computing environment is capable of being configured to include and/or use one or more aspects of the present disclosure. For instance, each may be configured to provide, process and/or use an intelligent workflow, to dynamically generate and deliver descriptor-based content and/or perform one or more other aspects of the present disclosure.

In addition to the above, one or more aspects may be provided, offered, deployed, managed, serviced, etc. by a service manager who offers management of customer environments. For instance, the service manager can create, maintain, support, etc. computer code and/or a computer infrastructure that performs one or more aspects for one or more customers. In return, the service manager may receive payment from the customer under a subscription and/or fee agreement, as examples. Additionally, or alternatively, the service manager may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other projects, project-templates, role-descriptors and/or task-descriptors may be defined. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A method comprising:
registering, on at least one computing device of a computing environment using a registration mechanism, a role-descriptor of a selected project to provide context regarding the role-descriptor the registering the role-descriptor indicating a content format customized for the role-descriptor;
executing, on the at least one computing device, an artificial intelligence workflow to dynamically generate content to be delivered for the role-descriptor, the artificial intelligence workflow being an orchestration of automation, artificial intelligence and analytics to dynamically generate the content to be delivered for the role-descriptor, the executing the artificial intelligence workflow including:
accessing a template repository that stores project-templates that are reusable templates defined for projects and selecting from the template repository a project-template for the selected project, the project-template including a set of role-descriptors and a task-descriptor graph, the set of role-descriptors including one or more role-descriptors describing one or more roles relating to the selected project represented by the project-template, the one or more role-descriptors including the role-descriptor that is registered, and the task-descriptor graph including a plurality of task-descriptors and one or more weights for the plurality of task-descriptors to indicate relative importance of one or more task-descriptors for at least one role-descriptors of the set of role-descriptors;
executing an artificial intelligence application to dynamically generate and deliver descriptor-based content based on a request for content for the role-descriptor of the set of role-descriptors, the artificial intelligence application including one or more artificial intelligence models trained to generate the descriptor-based content, the descriptor-based content including content based on the role-descriptor and at least one task-descriptor of the task-descriptor graph;
automatically adjusting using the artificial intelligence application at least one weight of the one or more weights based on the role-descriptor specified in the request, the automatically adjusting generating at least one adjusted weight;
tagging, using the artificial intelligence application, data obtained based on the set of role-descriptors and the task-descriptor graph of the project-template to generate tagged data, the artificial intelligence application being trained and continuously retrained on how to generate the tagged data based on the set of role-descriptors and the task-descriptor graph;
storing the tagged data in a repository, wherein the tagged data is stored in lieu of storing the descriptor-based content that is dynamically generated to reduce use of storage of the computing environment;
dynamically generating descriptor-based content to be delivered based on the request, the generating the descriptor-based content using the artificial intelligence application to dynamically generate from the tagged data stored in the repository the descriptor-based content, the generating the descriptor-based content being based on the role-descriptor and the task-descriptor graph, and including, traversing the task-descriptor graph to select, based on the one or more weights including the at least one adjusted weight, one or more task-descriptors of the plurality of task-descriptors and using the one or more task-descriptors that are selected to choose content to dynamically generate the descriptor-based content, wherein the dynamically generating the descriptor-based content is in lieu of storing multiple versions of content, which reduces maintenance of the multiple versions of content and use of storage in the computing environment;
delivering the descriptor-based content, wherein the descriptor-based content delivered is specific to the role-descriptor and in the content format customized for the role-descriptor as defined by the registering; and
retraining at least one artificial intelligence model of the artificial intelligence application to produce a re-trained artificial intelligence application that improves processing on a next iteration, the retraining being based on the set of role-descriptors, the task-descriptor graph and the tagging and wherein the re-trained artificial intelligence application is used to generate the descriptor-based content for another request.

2. The method of claim 1, wherein the task-descriptor graph is an N-dimensional directed acyclic graph, where N is at least one.

3. The method of claim 1, wherein a task-descriptor of the task-descriptor graph has associated therewith one or more content descriptions for the role-descriptor, and wherein the generating the descriptor-based content is further based on the one or more content descriptions.

4. The method of claim 3, wherein the one or more content descriptions for the task-descriptor are part of the project-template created for the selected project.

5. The method of claim 1, wherein the delivering the descriptor-based content includes generating a visual representation of the descriptor-based content and providing the visual representation to a requester of the request.

6. (canceled)

7. The method of claim 1, wherein other descriptor-based content delivered for another role-descriptor of the set of role-descriptors is of another format specified for that another role-descriptor, the another format being different from the format specified for the role-descriptor.

8. The method of claim 1, further comprising automatically updating the descriptor-based content to be delivered for the role-descriptor based on an indication that the tagged data has been modified.

9. The method of claim 1, wherein the role-descriptor has a relationship with at least one other role-descriptor of the set of role-descriptors, and wherein at least a portion of the descriptor-based content is deliverable for the at least one other role-descriptor of the set of role-descriptors.

10. (canceled)

11. A computer program product comprising:
a set of one or more computer-readable storage media; and
program instructions, collectively stored in the set of one or more computer-readable storage media, for causing one or more computing devices to perform computer operations including:
registering, on at least one computing device of a computing environment using a registration mechanism a role-descriptor of a selected project to provide context regarding the role-descriptor, the registering the role-descriptor indicating a content format customized for the role-descriptor;
executing on the at least one computing device an artificial intelligence workflow to dynamically generate content to be delivered for the role-descriptor, the artificial intelligence workflow being an orchestration of automation, artificial intelligence and analytics to dynamically generate the content to be delivered for the role-descriptor, the executing the artificial intelligence workflow including:
accessing a template repository that stores project-templates that are reusable templates defined for projects and selecting from the template repository a project-template for the selected project, the project-template including a set of role-descriptors and a task-descriptor graph, the set of role-descriptors including one or more role-descriptors describing one or more roles relating to the selected project represented by the project-template, the one or more role-descriptors including the role-descriptor that is registered and the task-descriptor graph including a plurality of task-descriptors and one or more weights for the plurality of task-descriptors to indicate relative importance of one or more task-descriptors for at least one role-descriptors of the set of role-descriptors;
executing an artificial intelligence application to dynamically generate and deliver descriptor-based content based on a request for content for the role-descriptor of the set of role-descriptors, the artificial intelligence application including one or more artificial intelligence models trained to generate the descriptor-based content, the descriptor-based content including content based on the role-descriptor and at least one task-descriptor of the task-descriptor graph;
automatically adjusting using the artificial intelligence application at least one weight of the one or more weights based on the role-descriptor specified in the request, the automatically adjusting generating at least one adjusted weight;
tagging, using the artificial intelligence application, data obtained based on the set of role-descriptors and the task-descriptor graph of the project-template to generate tagged data, the artificial intelligence application being trained and continuously retrained on how to generate the tagged data based on the set of role-descriptors and the task descriptor graph;
storing the tagged data in a repository, wherein the tagged data is stored in lieu of storing the descriptor-based content that is dynamically generated to reduce use of storage of the computing environment;
dynamically generating descriptor-based content to be delivered based on the request, the generating the descriptor-based content using the artificial intelligence application to dynamically generate from the tagged data stored in the repository the descriptor-based content, the generating the descriptor-based content being based on the role-descriptor and the task-descriptor graph, and including, traversing the task-descriptor graph to select, based on the one or more weights including the at least one adjusted weight, one or more task-descriptors of the plurality of task-descriptors and using the one or more task-descriptors that are selected to choose content to dynamically generate the descriptor-based content, wherein the dynamically generating the descriptor-based content is in lieu of storing multiple versions of content, which reduces maintenance of the multiple versions of content and use of storage in the computing environment; and
delivering the descriptor-based content, wherein the descriptor-based content delivered is specific to the role-descriptor and in the content format customized for the role-descriptor as defined by the registering; and
retraining at least one artificial intelligence model of the artificial intelligence application to produce a re-trained artificial intelligence application that improves processing on a next iteration, the retraining being based on the set of role-descriptors, the task-descriptor graph and the tagging, and wherein the re-trained artificial intelligence application is used to generate the descriptor-based content for another request.

12. The computer program product of claim 11, wherein the task-descriptor graph is an N-dimensional directed acyclic graph, where N is at least one.

13. The computer program product of claim 11, wherein a task-descriptor of the task-descriptor graph has associated therewith one or more content descriptions for the requesting role-descriptor, and wherein the generating the descriptor-based content is further based on the one or more content descriptions.

14. The computer program product of claim 13, wherein the one or more content descriptions for the task-descriptor are part of the project-template created for the selected project.

15. The computer program product of claim 11, wherein the requesting role-descriptor has a relationship with at least one other role-descriptor of the set of role-descriptors, and wherein at least a portion of the descriptor-based content is deliverable for the at least one other role-descriptor of the set of role-descriptors.

16. (canceled)

17. A computer system comprising:
one or more computing devices;
a set of one or more computer-readable storage media; and
program instructions, collectively stored in the set of one or more computer-readable storage media, for causing the one or more computing devices to perform computer operations including:
registering, on at least one computing device of a computing environment using a registration mechanism, a role-descriptor of a selected project to provide context regarding the role-descriptor, the registering the role-descriptor indicating a content format customized for the role-descriptor;
executing, on the at least one computing device an artificial intelligence workflow to dynamically generate content to be delivered for the role-descriptor. the artificial intelligence workflow being an orchestration of automation, artificial intelligence and analytics to dynamically generate the content to be delivered for the role-descriptor, the executing the artificial intelligence workflow including:
accessing a template repository that stores project-templates that are reusable templates defined for projects and selecting from the template repository a project-template for the selected project, the project-template including a set of role-descriptors and a task-descriptor graph, the set of role-descriptors including one or more role-descriptors describing one or more roles relating to the selected project represented by the project-template, the one or more role-descriptors including the role-descriptor that is registered and the task-descriptor graph including a plurality of task-descriptors and one or more weights for the plurality of task-descriptors to indicate relative importance of one or more task-descriptors for at least one role-descriptors of the set of role-descriptors;
executing an artificial intelligence application to dynamically generate and deliver descriptor-based content based on a request for content for the role-descriptor of the set of role-descriptors, the artificial intelligence application including one or more artificial intelligence models trained to generate the descriptor-based content, the descriptor-based content including content based on the role-descriptor and at least one task-descriptor of the task-descriptor graph;
automatically adjusting using the artificial intelligence application at least one weight of the one or more weights based on the role-descriptor specified in the request, the automatically adjusting generating at least one adjusted weight;
tagging, using the artificial intelligence application, data obtained based on the set of role-descriptors and the task-descriptor graph of the project-template to generate tagged data, the artificial intelligence application being trained and continuously retrained on how to generate the tagged data based on the set of role-descriptors and the task-descriptor graph;
storing the tagged data in a repository, wherein the tagged data is stored in lieu of storing the descriptor-based content that is dynamically generated to reduce use of storage of the computing environment;
dynamically generating descriptor-based content to be delivered based on the request, the generating the descriptor-based content using the artificial intelligence application to dynamically generate from the tagged data stored in the repository the descriptor-based content, the generating the descriptor-based content being based on the role-descriptor and the task-descriptor graph, and including, traversing the task-descriptor graph to select, based on the one or more weights including the at least one adjusted weight, one or more task-descriptors of the plurality of task-descriptors and using the one or more task-descriptors that are selected to choose content to dynamically generate the descriptor-based content, wherein the dynamically generating the descriptor-based content is in lieu of storing multiple versions of content, which reduces maintenance of the multiple versions of content and use of storage in the computing environment;
delivering the descriptor-based content, wherein the descriptor-based content delivered is specific to the role-descriptor and in the content format customized for the role-descriptor as defined by the registering; and
retraining at least one artificial intelligence model of the artificial intelligence application to produce a re-trained artificial intelligence application that improves processing on a next iteration, the retraining being based on the set of role-descriptors, the task-descriptor graph and the tagging, and wherein the re-trained artificial intelligence application is used to generate the descriptor-based content for another request.

18. The computer system of claim 17, wherein the task-descriptor graph is an N-dimensional directed acyclic graph, where N is at least one.

19. The computer system of claim 17, wherein a task-descriptor of the task-descriptor graph has associated therewith one or more content descriptions for the role-descriptor, and wherein the generating the descriptor-based content is further based on the one or more content descriptions.

20. The computer system of claim 17, wherein the role-descriptor has a relationship with at least one other role-descriptor of the set of role-descriptors, and wherein at least a portion of the descriptor-based content is deliverable for the at least one other role-descriptor of the set of role-descriptors.

21. The computer system of claim 17, wherein the computer operations further comprise automatically updating the descriptor-based content to be delivered for the role-descriptor based on an indication that the tagged data has been modified.

22. The computer-program product of claim 11, wherein the computer operations further comprise automatically updating the descriptor-based content to be delivered for the role-descriptor based on an indication that the tagged data has been modified.

23. The computer-program product of claim 11, wherein other descriptor-based content delivered for another role-descriptor of the set of role-descriptors is of another format specified for that another role-descriptor, the another format being different from the format specified for the role-descriptor.
